(19) United States
(12) Patent Application Publication
(10) Pub. No.: US 2025/0227614 A1
(43) Pub. Date: Jul. 10, 2025

(54) GROUP COMMON CELL DISCONTINUOUS RECEPTION COMMANDS

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US)

(21) Appl. No.: 18/977,785

(22) Filed: Dec. 11, 2024

Related U.S. Application Data
(60) Provisional application No. 63/619,176, filed on Jan. 9, 2024.

(51) Int. Cl. H04W 52/02; H04W 72/0446; H04W 72/231

(52) U.S. Cl. CPC H04W 52/0219; H04W 52/0235; H04W 72/231; H04W 76/28

(57) ABSTRACT

Methods, systems, and devices for wireless communications are described. A first user equipment (UE) may receive a group common command from a network entity that indicates a transition to a UE sleep mode. The network entity may transmit the group common command to one or more UEs, including the first UE, and may subsequently transition to the sleep mode. The command may include an indication for the one or more UEs to transition to the sleep mode. For example, the command may indicate a quantity of slots during which the group of UEs may remain in the sleep mode. In some examples, the command may indicate a set of channels for each UE of the group of UEs to monitor or use for signal transmission or reception during the sleep mode. Thus, UE sleep modes may be aligned so that the network entity may enter a cell sleep mode.

### CROSS REFERENCE

The present Application for Patent claims the benefit of Provisional Patent Application No. 63/619,176 by YANG et al., entitled “GROUP COMMON CELL DISCONTINUOUS RECEPTION COMMANDS,” filed Jan. 9, 2024, assigned to the assignee hereof and hereby expressly incorporated by reference herein.

### FIELD OF TECHNOLOGY

The following relates to wireless communications, including group common cell discontinuous reception commands.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support group common cell discontinuous reception commands. For example, the described techniques provide for a first user equipment (UE) to receive a command from a network entity that indicates a transition to a sleep mode. For example, the network entity may transmit the command (e.g., a Group cell discontinuous reception (C-DRX) command) to one or more UEs, including the first UE, and may subsequently transition to the sleep mode (e.g., a discontinuous transmission (DRX) mode, a discontinuous transmission (DTX) mode, or both). The command may include an indication for the one or more UEs to transition to the sleep mode (e.g., the DRX mode). In some cases, the command may indicate a quantity of slots during which the group of UEs may remain in the sleep mode. Similarly, the command may indicate an extended sleep mode. For example, the command may indicate a duration (e.g., an extended duration) for the group of UEs to remain in the sleep mode.

In some examples, the command may indicate a physical uplink channel that each UE of the group of UEs may use for signal transmissions while the network entity, the group of UEs, or both are in the sleep mode. Similarly, the command may indicate a physical downlink channel that each UE of the group of UEs may monitor while in the sleep mode. For example, the command may indicate a configured periodicity (e.g., adjusted or non-adjusted), and each UE may monitor the physical channel according to the configured periodicity. Additionally, or alternatively, the command may indicate that each UE may perform procedures (e.g., a radio resource control (RRC) reestablishment procedure, a handover procedure, a redirection procedure) on a set of neighbor cells or neighbor frequencies. In some cases, the network entity may select the group of UEs based on a reference signal received power (RSRP) reported by a set of UEs. For example, the network entity may select UEs to be part of a same group based on cell distance (e.g., near cell, mid cell, far cell, and so on). Thus, UE C-DRX modes at the group of UEs may be aligned so that the network entity may enter a sleep mode.

A method for wireless communications by a UE is described. The method may include receiving, at the first UE and while the first UE is in communication with a first cell, a group common command that indicates that a set of multiple UEs is to enter a sleep mode for a duration of time, where the sleep mode is with respect to communications with the first cell, and where the group common command indicates a configuration for the sleep mode, the set of multiple UEs including the first UE. The method may further include transitioning, based on receiving the group common command, to the sleep mode, monitoring, during the duration of time, one or more downlink channels in the first cell in accordance with the configuration for the sleep mode; and transmitting, during the duration of time, one or more uplink channels in the first cell in accordance with the configuration for the sleep mode.

A first UE for wireless communications is described. The first UE may include one or more memories storing processor executable code, and one or more processors coupled with the one or more memories. The one or more processors may individually or collectively operable to execute the code to cause the first UE to receive, at the first UE and while the first UE is in communication with a first cell, a group common command that indicates that a set of multiple UEs is to enter a sleep mode for a duration of time, where the sleep mode is with respect to communications with the first cell, and where the group common command indicates a configuration for the sleep mode, the set of multiple UEs including the first UE. The one or more processors may individually or collectively operable to execute the code to cause the first UE to transition, based on receiving the group common command, to the sleep mode, monitor, during the duration of time, one or more downlink channels in the first cell in accordance with the configuration for the sleep mode, and transmit, during the duration of time, one or more uplink channels in the first cell in accordance with the configuration for the sleep mode.

Another first UE for wireless communications is described. The first UE may include means for receiving, at the first UE and while the first UE is in communication with a first cell, a group common command that indicates that a set of multiple UEs is to enter a sleep mode for a duration of time, where the sleep mode is with respect to communications with the first cell, and where the group common command indicates a configuration for the sleep mode, the set of multiple UEs including the first UE. The first UE may include means for transitioning, based on receiving the group common command, to the sleep mode, means for monitoring, during the duration of time, one or more downlink channels in the first cell in accordance with the configuration for the sleep mode, and means for transmitting, during the duration of time, one or more uplink channels in the first cell in accordance with the configuration for the sleep mode.

A non-transitory computer-readable medium storing code for wireless communications is described. The code may include instructions executable by one or more processors to receive, at the first UE and while the first UE is in communication with a first cell, a group common command that indicates that a set of multiple UEs is to enter a sleep mode for a duration of time, where the sleep mode is with respect to communications with the first cell, and where the group common command indicates a configuration for the sleep mode, the set of multiple UEs including the first UE. The code may include instructions executable by one or more processors to transition, based on receiving the group common command, to the sleep mode, monitor, during the duration of time, one or more downlink channels in the first cell in accordance with the configuration for the sleep mode, transmit, during the duration of time, one or more uplink channels in the first cell in accordance with the configuration for the sleep mode.

Some examples of the method, first UEs, and non-transitory computer-readable medium described herein may further include operations, features, means, or instructions for receiving, prior to receiving the group common command, control signaling that indicates a configuration for the group common command, where the group common command may be received in accordance with the configuration for the group common command.

In some examples of the method, first UEs, and non-transitory computer-readable medium described herein, the control signaling includes a radio resource control signal.

In some examples of the method, first UEs, and non-transitory computer-readable medium described herein, the control signaling assigns the first UE into a UE group for receiving the group common command and the UE group includes the set of multiple UEs.

In some examples of the method, first UEs, and non-transitory computer-readable medium described herein, the first UE may be assigned to the UE group based on a reference signal measurement, a location of the first UE within the first cell, a mobility condition of the first UE within the first cell, an application quality of experience (QoE), or a combination thereof.

In some examples of the method, first UEs, and non-transitory computer-readable medium described herein, receiving the group common command may include operations, features, means, or instructions for receiving the configuration that indicates a quantity of slots during which the first UE may be to remain in the sleep mode for the communications with the first cell, where the first UE monitors the one or more downlink channels during the quantity of slots.

In some examples of the method, first UEs, and non-transitory computer-readable medium described herein, receiving the group common command may include operations, features, means, or instructions for receiving the configuration that indicates the one or more downlink channels that the first UE may be to monitor in accordance with the sleep mode, a periodicity for monitoring the one or more downlink channels, or both.

In some examples of the method, first UEs, and non-transitory computer-readable medium described herein, receiving the group common command may include operations, features, means, or instructions for receiving the configuration that indicates one or more uplink channels that the first UE may be to use for uplink transmission in accordance with the sleep mode, a periodicity for the one or more uplink channels, or both.

In some examples of the method, first UEs, and non-transitory computer-readable medium described herein, receiving the group common command may include operations, features, means, or instructions for receiving the group common command that indicates a set of neighboring cells.

Some examples of the method, first UEs, and non-transitory computer-readable medium described herein may further include operations, features, means, or instructions for performing a radio resource control reestablishment procedure, a handover procedure, or a redirection procedure with a second cell of the set of neighboring cells based on the group common command.

Some examples of the method, first UEs, and non-transitory computer-readable medium described herein may further include operations, features, means, or instructions for receiving, based on monitoring during the sleep mode, control signaling that indicates an extended sleep instruction, where the first UE remains in the sleep mode for an extended duration of time based on the extended sleep instruction.

In some examples of the method, first UEs, and non-transitory computer-readable medium described herein, the configuration for the sleep mode overrides a discontinuous reception cycle configured at the first UE.

In some examples of the method, first UEs, and non-transitory computer-readable medium described herein, the sleep mode includes a discontinuous transmission mode, a discontinuous reception mode, or both.

A method for wireless communications by a network entity is described. The method may include outputting a group common command that indicates that a set of multiple user UEs in communication with a first cell is to enter a sleep mode for a duration of time, where the sleep mode is with respect to communications with the first cell, and where the group common command indicates a configuration for the sleep mode. The method may include transitioning, based on outputting the group common command, to the sleep mode, and monitoring, during the duration of time, one or more uplink channels in the first cell in accordance with the configuration for the sleep mode.

A network entity for wireless communications is described. The network entity may include one or more memories storing processor executable code, and one or more processors coupled with the one or more memories. The one or more processors may individually or collectively operable to execute the code to cause the network entity to output a group common command that indicates that a set of multiple UEs in communication with a first cell is to enter a sleep mode for a duration of time, where the sleep mode is with respect to communications with the first cell, and where the group common command indicates a configuration for the sleep mode. The one or more processors may individually or collectively operable to execute the code to cause the network entity to transition, based on outputting the group common command, to the sleep mode, and to monitor, during the duration of time, one or more uplink channels in the first cell in accordance with the configuration for the sleep mode.

Another network entity for wireless communications is described. The network entity may include means for outputting a group common command that indicates that a set of multiple UEs in communication with a first cell is to enter a sleep mode for a duration of time, where the sleep mode is with respect to communications with the first cell, and where the group common command indicates a configuration for the sleep mode. The network entity may include means for transitioning, based on outputting the group common command, to the sleep mode, and means for monitoring, during the duration of time, one or more uplink channels in the first cell in accordance with the configuration for the sleep mode.

A non-transitory computer-readable medium storing code for wireless communications is described. The code may include instructions executable by one or more processors to output a group common command that indicates that a set of multiple UEs in communication with a first cell is to enter a sleep mode for a duration of time, where the sleep mode is with respect to communications with the first cell, and where the group common command indicates a configuration for the sleep mode. The code may include instructions executable by one or more processors to transition, based on outputting the group common command, to the sleep mode, and to monitor, during the duration of time, one or more uplink channels in the first cell in accordance with the configuration for the sleep mode.

Some examples of the method, network entities, and non-transitory computer-readable medium described herein may further include operations, features, means, or instructions for outputting, prior to outputting the group common command, control signaling that indicates a configuration for the group common command, where the group common command may be output in accordance with the configuration for the group common command.

In some examples of the method, network entities, and non-transitory computer-readable medium described herein, the control signaling includes a radio resource control signal.

In some examples of the method, network entities, and non-transitory computer-readable medium described herein, the control signaling assigns one or more UEs into a UE group for receiving the group common command and the UE group includes the set of multiple UEs.

In some examples of the method, network entities, and non-transitory computer-readable medium described herein, the one or more UEs may be assigned to the UE group based on a reference signal measurement, a location of the one or more UEs within the first cell, an application QoE, or a combination thereof.

In some examples of the method, network entities, and non-transitory computer-readable medium described herein, outputting the group common command may include operations, features, means, or instructions for outputting the configuration that indicates a quantity of slots during which the set of multiple UEs may be to remain in the sleep mode for the communications with the first cell, where the network entity monitors the one or more uplink channels in accordance with the configuration.

In some examples of the method, network entities, and non-transitory computer-readable medium described herein, outputting the group common command may include operations, features, means, or instructions for outputting the configuration that indicates one or more downlink channels that the set of multiple UEs may be to monitor in accordance with the sleep mode, a periodicity for monitoring the one or more downlink channels, or both.

In some examples of the method, network entities, and non-transitory computer-readable medium described herein, outputting the group common command may include operations, features, means, or instructions for outputting the configuration that indicates the one or more uplink channels that the set of multiple UEs may be to use for uplink transmission in accordance with the sleep mode, a periodicity for the one or more uplink channels, or both.

In some examples of the method, network entities, and non-transitory computer-readable medium described herein, outputting the group common command may include operations, features, means, or instructions for outputting the group common command that indicates a set of neighboring cells.

Some examples of the method, network entities, and non-transitory computer-readable medium described herein may further include operations, features, means, or instructions for outputting, based on monitoring during the sleep mode, control signaling that indicates an extended sleep instruction, where the network entity remains in the sleep mode for an extended duration of time based on the extended sleep instruction.

In some examples of the method, network entities, and non-transitory computer-readable medium described herein, the configuration for the sleep mode overrides a discontinuous reception cycle configured at one or more UEs of the set of multiple UEs.

In some examples of the method, network entities, and non-transitory computer-readable medium described herein, the sleep mode includes a discontinuous transmission mode, a discontinuous reception mode, or both.

### BRIEF DESCRIPTION OF THE DRAWINGS

FIG. 1 shows an example of a wireless communications system that supports group common cell discontinuous reception commands in accordance with one or more aspects of the present disclosure.

FIG. 2 shows an example of a wireless communications system that supports group common cell discontinuous reception commands in accordance with one or more aspects of the present disclosure.

FIG. 3 shows an example of a process flow that supports group common cell discontinuous reception commands in accordance with one or more aspects of the present disclosure.

FIGS. 4 and 5 show block diagrams of devices that support group common cell discontinuous reception commands in accordance with one or more aspects of the present disclosure.

FIG. 6 shows a block diagram of a communications manager that supports group common cell discontinuous reception commands in accordance with one or more aspects of the present disclosure.

FIG. 7 shows a diagram of a system including a device that supports group common cell discontinuous reception commands in accordance with one or more aspects of the present disclosure.

FIGS. 8 and 9 show block diagrams of devices that support group common cell discontinuous reception commands in accordance with one or more aspects of the present disclosure.

FIG. 10 shows a block diagram of a communications manager that supports group common cell discontinuous reception commands in accordance with one or more aspects of the present disclosure.

FIG. 11 shows a diagram of a system including a device that supports group common cell discontinuous reception commands in accordance with one or more aspects of the present disclosure.

FIGS. 12 through 16 show flowcharts illustrating methods that support group common cell discontinuous reception commands in accordance with one or more aspects of the present disclosure.

### DETAILED DESCRIPTION

Techniques described herein relate to a first user equipment (UE), which may receive a command from a network entity that indicates a transition to the sleep mode. For example, the network entity may transmit the command (e.g., a Group Common cell discontinuous reception (C-DRX) command) to one or more UEs, including the first UE, and may subsequently transition to the sleep mode (e.g., a discontinuous transmission (DRX) mode, a discontinuous transmission (DTX) mode, or both). The command may include an indication for the one or more UEs to transition to the sleep mode (e.g., the DRX mode). In some cases, the command may indicate a quantity of slots during which the group of UEs may remain in the sleep mode. Similarly, the command may indicate an extended sleep mode. For example, the command may indicate a duration (e.g., an extended duration) for the group of UEs to remain in the sleep mode.

In some examples, the command may or a configuration associated with the command indicate a physical uplink channel that each UE of the group of UEs may use for signal transmissions while the network entity, the group of UEs, or both are in the sleep mode. Similarly, the command may indicate a physical downlink channel that each UE of the group of UEs may monitor while in the sleep mode. For example, the command may indicate a configured periodicity (e.g., adjusted or non-adjusted), and each UE may monitor the physical channel according to the configured periodicity. Additionally, or alternatively, the command or configuration may indicate that each UE may perform procedures (e.g., radio resource control (RRC) reestablishment) on a set of neighbor cells or neighbor frequencies. In some cases, the network entity may select the group of UEs based on a reference signal received power (RSRP) reported by a set of UEs. For example, the network entity may select UEs to be part of a same group based on cell distance (e.g., near cell, mid cell, far cell, and so on). Thus, UE C-DRX modes at the group of UEs may be aligned so that the network entity may enter a sleep mode.

Aspects of the disclosure are initially described in the context of wireless communications systems. Aspects of the disclosure are then described in the context of a process flow. Aspects of the disclosure are further illustrated by and described with reference to apparatus diagrams, system diagrams, and flowcharts that relate to group common cell discontinuous reception commands.

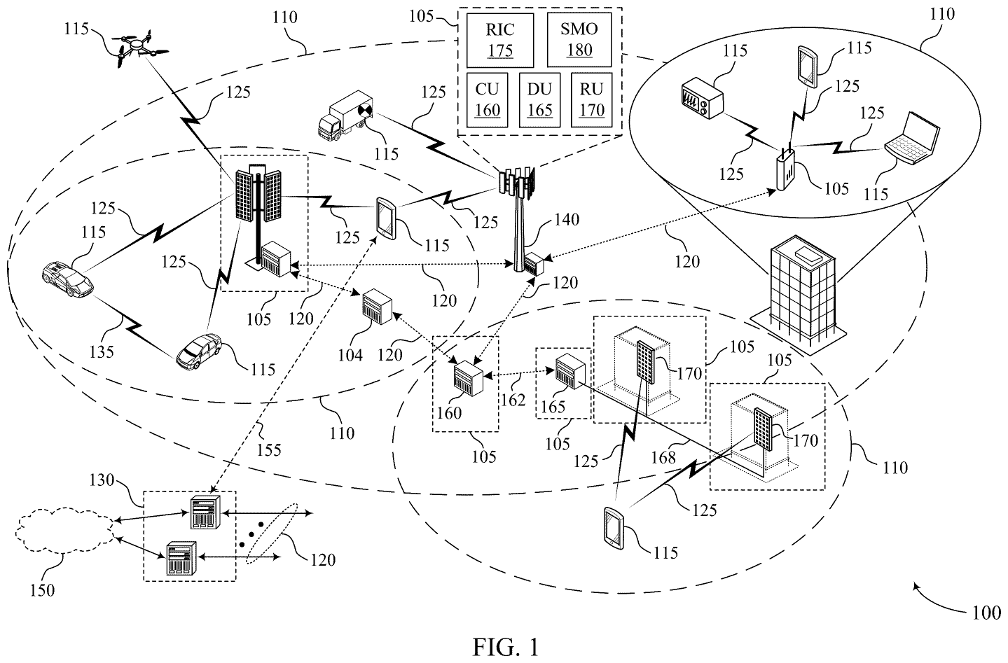

FIG. 1 shows an example of a wireless communications system 100 that supports group common cell discontinuous reception commands in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support group common cell discontinuous reception commands as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some wireless communications systems, aligning DTX and DRX may impact physical layer signals, channels, and procedures during inactive (e.g., non-active) period of cell DTX mode or DRX mode. In some cases, one or more devices may consider the impact to key performance indicators (KPIs) from system information when physical layer signals, channels, and procedures are impacted.

The wireless communications system 100 may support procedures to align DTX and DRX at a network entity 105 and DRX at one or more UEs 115 in a connected mode (e.g., RRC_CONNECTED mode). The wireless communications system 100 may further support inter-node information exchange while the network entity 105 operates in a sleep mode (e.g., operating in cell DTX mode or in cell DRX mode). For example, one or more network entities 105 may exchange information while the one or more network entities 105 operate in the sleep mode. In some cases, the network entity 105 may transmit synchronization signal blocks (SSBs) while operating in the sleep mode. The wireless communications system 100 may support avoiding an impact, by UEs 115 in an idle or an inactive mode, on the wireless communications system 100.

In some cases, a UE 115 may refrain from transmitting or receiving signals while a network entity 105 (e.g., a cell) is operating in the sleep mode or while the cell is in a non-active period of a cell DTX/DRX mode. For example, the UE 115 may refrain from receiving periodic or semi-persistent channel state information (CSI) reference signals (CSI-RS) including tracking reference signals (TRS), positioning reference signals (PRS), physical downlink control channel (PDCCH) messages scrambled with a UE-specific radio network temporary identifier (RNTI), PDCCH messages in type-3 common search space (CSS), semi-persistent scheduling (SPS) physical downlink shared channel (PDSCH) messages, or any combination thereof. Further, the UE 115 may refrain from transmitting scheduling requests, periodic or semi-persistent CSI reports, periodic or semi-persistent sounding reference signals (SRS), configured grant (CG) physical uplink shared channel (CG-PUSCH) messages, or any combination thereof. In some cases, the UE 115 may transmit or receive one or more other signals while the cell of the network entity 105 is in the sleep mode or in a non-active period of the cell DTX/DRX mode.

In some wireless communications systems, a UE 115 communicate according to C-DRX mode by periodically transitioning between the DRX mode (e.g., a “sleep” mode) and an active mode (e.g., a “wake up” mode). For example, the UE 115 in DRX mode may not transmit and/or receive various signals (e.g., the UE 115 is restricted from transmitting and/or receiving signals), while the UE 115 in active mode may be available to transmit and/or receive signals (e.g., no such restrictions on signal transmitting or receiving). The UE 115 may be configured with the C-DRX mode to conserve power. In some cases, a set of multiple UEs 115 may not perform C-DRX simultaneously. For example, a first UE 115 may have a different C-DRX offset than a second UE 115. Further, the first UE may experience different signal traffic than the second UE. Thus, the first UE 115 may be in DRX mode when the second UE 115 is in active mode, and the first UE 115 may be in active mode when the second UE 115 is in DRX mode. Such non-alignment of C-DRX periods may cause multiple devices (e.g., the multiple UEs 115 and/or one or more network entities 105 in communication with the multiple UEs 115) to inefficiently use communication resources, thus diminishing the user experience. For example, the non-alignment of C-DRX modes of UEs 115 may prohibit power saving at the network side, as the network may 105 remain in an active state to communicate with the different UEs 115 in the active state. Therefore, techniques that align C-DRX periods for multiple UEs 115 are desirable.

Techniques described herein may support aligning C-DRX modes at one or more UEs 115 so that the network entity 105 (e.g., a cell) may enter a sleep mode. A first UE 115 may receive a command from a network entity that indicates a transition to the sleep mode. For example, the network entity may transmit the command (e.g., a Group Common C-DRX command via a group common PDCCH) to one or more UEs 115, including the first UE 115, and may subsequently transition to the sleep mode (e.g., a DRX mode, a DTX mode, or both). The command may include an indication for the one or more UEs 115 to transition to the sleep mode (e.g., the DRX mode). In some cases, the command may indicate a quantity of slots during which the group of UEs 115 may remain in the sleep mode. Similarly, the command (or a subsequent command or signal) may indicate an extended sleep mode. For example, the command may indicate a duration (e.g., an extended duration) for the group of UEs 115 to remain in the sleep mode.

In some examples, the command may indicate a physical uplink channel that each UE 115 of the group of UEs 115 may use for signal transmissions while the network entity, the group of UEs 115, or both are in the sleep mode. Similarly, the command may indicate a physical downlink channel that each UE 115 of the group of UEs 115 may monitor while in the sleep mode. For example, the command may indicate a configured periodicity (e.g., adjusted or non-adjusted), and each UE 115 may monitor the physical channel according to the configured periodicity. Additionally, or alternatively, the command may indicate that each UE 115 may perform procedures (e.g., RRC reestablishment) on a set of neighbor cells or neighbor frequencies. In some cases, the network entity may select the group of UEs 115 based on an RSRP reported by a set of UEs 115. For example, the network entity may select UEs 115 to be part of a same group based on cell distance (e.g., near cell, mid cell, far cell, and so on). Thus, UE C-DRX modes at the group of UEs 115 may be aligned so that the network entity 105 may enter a sleep mode and thereby conserve power or energy resources.

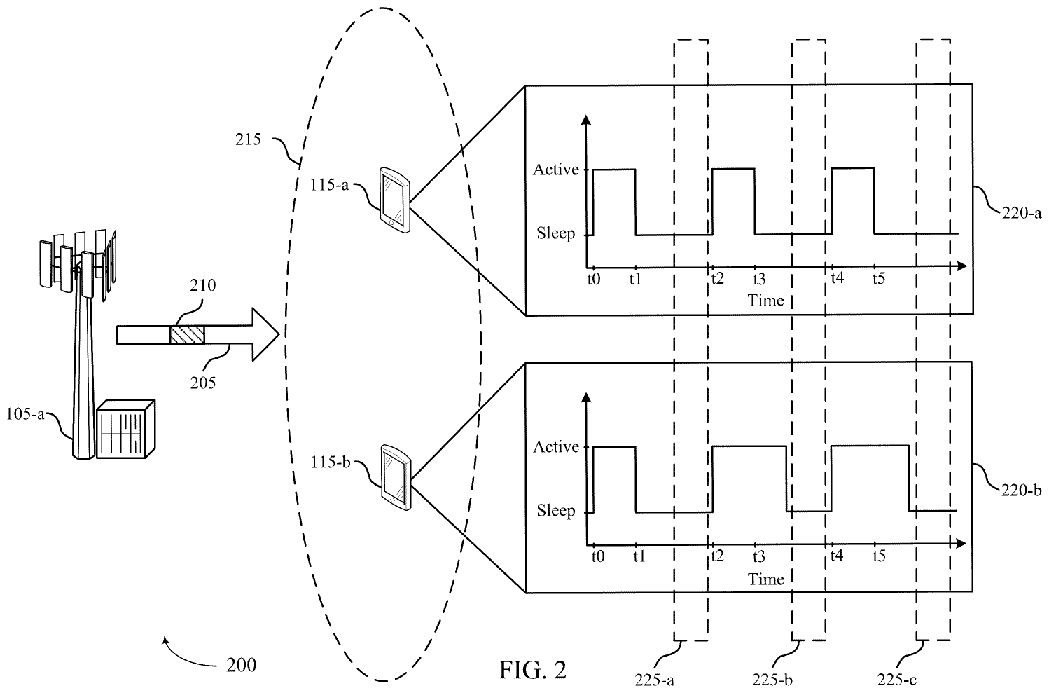

FIG. 2 shows an example of a wireless communications system 200 that supports group common cell discontinuous reception commands in accordance with one or more aspects of the present disclosure. In some cases, the wireless communications system 200 may implement or be implemented by aspects of the wireless communications system 100. For example, the wireless communications system 200 may include one or more UEs 115 (e.g., a UE 115-a and a UE 115-b) and one or more network entities 105 (e.g., a network entity 105-a), which may be examples of the corresponding devices as described herein. The network entity 105-a may communicate, via one or more wireless connections (e.g., a wireless connection 205), with a group of UEs 115 in communication with or operating in a first cell 215. The group of UEs may include the UE 115-a, the UE 115-b, one or more other UEs 115, or any combination thereof. In some cases, the network entity 105-a may transmit messages to the group of UEs 115 via the wireless connection 205.

In some cases, the network entity 105-a may transmit, via the wireless connection 205, a group common command 210 to the group of UEs 115 in communication with the first cell 215. The group common command may be an example of a group common C-DRX command carried in a group common PDCCH. Further, the group common command 210 may include a configuration for a UE sleep mode (e.g., a DRX mode). For example, the group of UEs 115 may modify one or more DRX cycles based on the configuration. That is, each UE 115 may be configured with separate DRX configurations that the UEs 115 may use for power saving purposes. However, the DRX modes (e.g., sleep states) of the DRX configurations may not be aligned in manner that may allow the network entity 105-a to enter a sleep state, as some UEs 115 may be in an active state while other UEs 115 may be an inactive state. As such, the group common DRX command may include a DRX configuration that overrides the individual DRX configurations of the UEs 115. Thus, after transmitting the group common command 210, the network entity 105-a may transition to a cell sleep mode (e.g., a DRX mode and/or a DTX mode).

Diagrams 220-a and 220-b illustrate sleep cycles (e.g., DRX cycles) at the group of UEs 115. For example, the diagram 220-a may represent a sleep cycle at the UE 115-a and the diagram 220-b may represent a sleep cycle at the UE 115-b. Each diagram 220 includes an x-axis representing time and a y-axis representing a current mode (e.g., a UE active mode or the UE sleep mode) of a respective UE 115. For example, the UE 115-a may transition from the UE sleep mode to the UE active mode at time t0. The UE 115-a may transition from the UE active mode to the UE sleep mode at time t1, back to the UE active mode at time t2, and so on. The group of UEs 115 (e.g., the UE 115-a and the UE 115-b) may share restriction windows 225 (e.g., the restriction windows 225-a, 225-b, and 225-c) in accordance with the group common C-DRX command. For example, each restriction window 225 of the restriction windows 225 may be an example of a duration during which at least a portion of the group of UEs 115 operate in the UE sleep mode. Thus, the network entity 105-b may cause the group of UEs 115 to enter the UE sleep mode, via the group common command 210, during each restriction window 225. Similarly, the network entity 105-a may enter the cell sleep mode during each restriction window 225.

In some cases, the group common command 210 may indicate a quantity of slots associated with the UE sleep mode. In such cases, the group of UEs 115 may remain in the UE sleep mode for the quantity of slots based on the group common command 210. Additionally, or alternatively, the group common command 210 may indicate a duration (e.g., a number of milliseconds) associated with the UE sleep mode, and the group of UEs 115 may remain in the UE sleep mode for the quantity of slots. The network entity 105-a may also enter the sleep mode for the duration (e.g., quantity of milliseconds or the quantity of slots).

In some implementations, the group common command 210 may indicate a set of uplink channels (e.g., uplink physical channels). The group of UEs 115 may use one or more uplink channels of the set of uplink channels to transmit uplink signals while the group of UEs 115 is operating in the UE sleep mode. For example, the group of UEs 115 may transmit uplink signals such as scheduling requests via physical uplink control channel (PUCCH), SRS with an adjusted configured periodicity (e.g., an existing scheduling request periodicity multiplied by some value), or any combination thereof. The group common command 210 may indicate the adjusted configured periodicity. In some cases, the group common command 210 may overwrite configured C-DRX properties such as a C-DRX offset, periodicity, or other properties, such as individual DRX configurations at each of the UEs 115.

In some cases, the group common command 210 may indicate a set of downlink channels (e.g., physical downlink channels). The group of UEs 115 may monitor one or more downlink channels of the set of downlink channels while the group of UEs 115 is operating in the UE sleep mode. In some cases, the group common command 210 may indicate a monitoring periodicity, which may be an adjusted or non-adjusted configured periodicity (e.g., an existing scheduling request periodicity multiplied by some value). The group of UEs 115 may monitor the one or more downlink channels in accordance with the group common command 210 and the monitoring periodicity. While the group of UEs 115 is operating in the UE sleep mode, the group of UEs 115 may monitor for signals such as CSI-RS, TRS, PRS, Common PDCCH messages, or any combination thereof (e.g., based on the indication of the channels and/or monitoring periodicity in the group common command 210).

The group common command 210 may indicate one or more neighbor cells, one or more frequencies, or both. That is, the group common command 210 may indicate neighbor cell frequencies associated with active cells, so that UEs 115 may perform cell-reselection in the other cell if the UE 115-a needs communication resources that are unavailable in a sleep or DRX mode. In some cases, one or more of the group of UEs 115 may perform radio communication procedures such as a fast radio link failure (RLF) procedure, an RRC reestablishment procedure, a handover procedure, a redirection procedure, or any combination thereof, in the neighboring cell. For example, the group of UEs 115 may perform the radio procedures with the one or more neighbor cells, via the one or more frequencies, or both. Thus, the group of UEs 115 may establish connections with at least one of the one or more neighbor cells and communicate with them such that the network entity 105-a may enter the cell sleep mode.

In some cases, the group common command 210 (or a subsequent group common command to the group common command 210) may indicate an extended sleep instruction. The extended sleep instruction may indicate that the group of UEs 115 is to remain in the UE sleep mode for an extended duration. After receiving the extended sleep instruction, the group of UEs 115 may remain in the UE sleep mode for a duration which is longer than a previously indicated or previously configured duration. For example, a previously indicated duration may cause the UE 115-a and the UE 115-b to enter the UE sleep mode from time t1 to time t2, and the extended sleep instruction may cause the UE 115-a and the UE 115-b to remain in the UE sleep mode from time t1 to time t3.

In some cases, the network entity 105-a may assign a set of UEs 115 into the group of UEs 115 based on reports from the set of UEs 115, based on physical distance from the network entity 105-a, or both. For example, the UE 115-a may transmit a first reference signal measurement (e.g., an RSRP) to the network entity 105-a. Similarly, the UE 115-b may transmit a second reference signal measurement to the network entity 105-a. In some cases, the network entity 105-a may determine (e.g., calculate) the first and second reference signal measurements based at least in part on signals received at the network entity 105-a. The network entity 105-a may assign the UE 115-a and the UE 115-b into a same UE group (e.g., the group of UEs 115) based on the first reference signal measurement and the second reference signal measurement. For example, the network entity 105-a may assign one or more groups of UEs 115 according to cells associated with the set of UEs 115 (e.g., according to the cells in which the set of UEs 115 operate or according to the cells with which the set of UEs 115 communicate). Thus, the network entity 105-a may configure a first group of UEs 115 in communication with a near cell, a second group of UEs 115 in communication with a mid-cell, and a third group of UEs 115 in communication with a far cell.

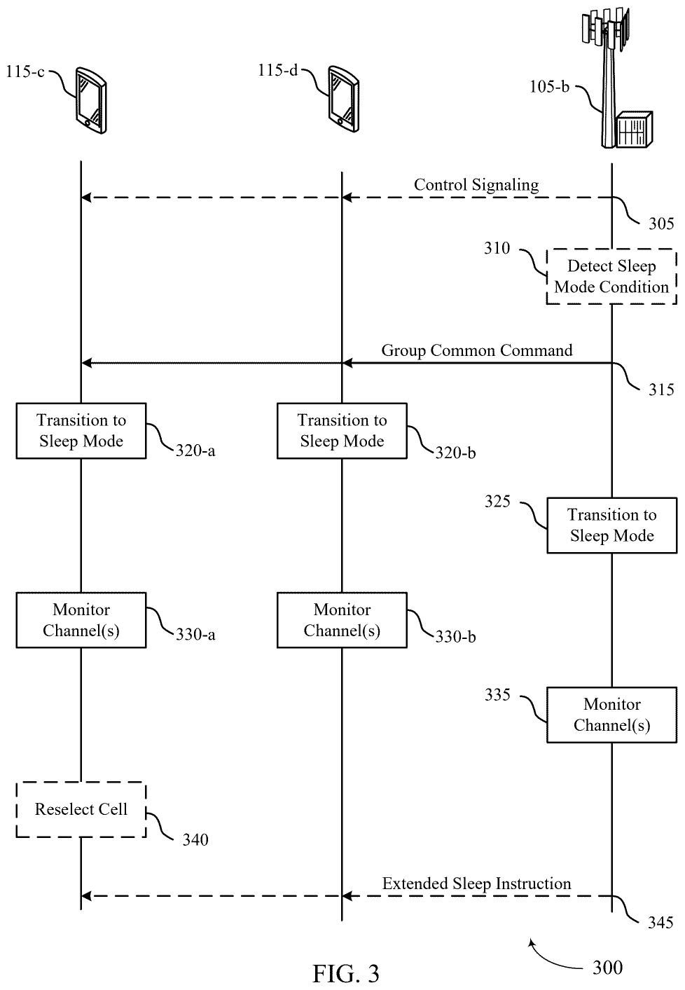

FIG. 3 shows an example of a process flow 300 that supports group common cell discontinuous reception commands in accordance with one or more aspects of the present disclosure. The process flow 300 includes a UE 115-c, a UE 115-d, and a network entity 105-b, which may be examples of the corresponding devices as described with respect to FIGS. 1 and 2. Operations performed by at least one of the UEs 115-c and 115-d may also be performed by other UEs 115 of a group of UEs 115, which may include the UEs 115-c and 115-d. In the following description of the process flow 300, the operations between the UE 115-c, the UE 115-d, and the network entity 105-b may be performed in a different order than the example order shown. Some operations may also be omitted from the process flow 300, and other operations may be added to the process flow 300. Further, although some operations or signaling may be shown to occur at different times for discussion purposes, these operations may actually occur at the same time.

In some cases, at 305, the UE 115-c and the UE 115-d may receive, control signaling that indicates a configuration for a group common command. The configuration may indicate group common resources that the UEs 115-c and/or 115-d are to monitor for receiving the group common command. In some cases, the control signaling may be an example of an RRC signal. The control signaling may assign the UE 115-c into a UE group (e.g., the group of UEs 115) for receiving the group common command (e.g., group common PDCCH). In some cases, the UE 115-c may transmit, to the network entity 105-b, a set of information including a reference signal measurement (e.g., an RSRP), a location of the UE 115-c, an application QoE metric for the UE, or any combination thereof. In some cases, the control signaling may be indicative of a configuration for the sleep mode. The network entity 105-b may assign the UE 115-c to the group of UEs 115 based on the set of information.

At 310, the network entity 105-b may optionally detect a condition associated with a cell sleep mode. In some cases, the network entity 105-b may determine to enter the cell sleep mode based on the condition, configured settings at the network entity 105-b, one or more signals received at the network entity 105-b, or any combination thereof.

The group of UEs 115, including the UEs 115-c and 115-d, may individually or collectively perform a set of operations. For example, at 315, the UE 115-c may receive, from the network entity 105-b and while the UE 115-c is in communication with a first cell, a group common command (e.g., MAC-CE or PDCCH DCI) that indicates that the group of UEs 115 is to enter a UE sleep mode for a duration of time. The group common command may be received in accordance with the configuration received at 305 via the control signaling. In some cases, the UE sleep mode and the cell sleep mode may be a same sleep mode (e.g., with corresponding configurations). The UE sleep mode may be with respect to communications with the first cell. For example, while the UE 115-c is in the UE sleep mode, the UE 115-c may refrain from transmitting a first set of signals to the first cell (e.g., or to the network entity 105-b) or receiving signals from the first cell. In some cases, UE 115-c may transmit and/or receive a limited set of signals while in the UE sleep mode. In some cases, sleep modes (e.g., the cell sleep mode and the UE sleep mode) may refer to a discontinuous transmission mode, a discontinuous reception mode, or both.

The group common command or the configuration for the sloop mode activated by the group common command may indicate a configuration for the UE sleep mode. For example, the configuration may indicate a quantity of slots during which the UE 115-c is to remain in the sleep mode for the communications with the first cell. The UE 115-c may monitor the one or more downlink channels during the quantity of slots. In some cases, the configuration may indicate the one or more downlink channels that the UE 115-c is to monitor in accordance with the sleep mode, a periodicity for monitoring the one or more downlink channels, or both. Additionally, or alternatively, the configuration may indicate one or more uplink channels that the UE 115-c is to use for uplink transmission in accordance with the sleep mode, a periodicity for the one or more uplink channels, or both. In some cases, the configuration for the sleep mode may override a discontinuous reception cycle configured at the UE 115-c. In some examples, the group common command may indicate a set of neighboring cells (e.g., neighboring cell frequencies). The configuration of the UE sleep mode may be common for both the UE 115-c and the UE 115-d.

At 320-a, the UE 115-c (and each UE 115 in the group of UEs 115) may transition, based on receiving the group common command, to the UE sleep mode. Similarly, at 320-b, the UE 115-d may transition, based on receiving the group common command, to the UE sleep mode.

At 325, the network entity 105-b may transition, based on outputting the group common command, to the cell sleep mode. For example, the network entity may remain in the cell sleep mode in accordance with a restriction window 225 (e.g., the restriction window 225-a).

At 330-a, the UE 115-c (and each UE 115 in the group of UEs 115) may monitor, during the duration of time, one or more downlink channels in the first cell in accordance with the configuration for the UE sleep mode. Similarly, at 330-b, the UE 115-d may monitor, during the duration of time, one or more downlink channels in the first cell in accordance with the configuration for the UE sleep mode. For example, While the group of UEs 115 is operating in the UE sleep mode, the group of UEs 115 may monitor for signals such as CSI-RS, TRS, PRS, Common PDCCH messages, or any combination thereof.

At 335, the network entity 105-b may monitor, during the duration of time, one or more uplink channels in the first cell in accordance with the configuration for the cell sleep mode. For example, the network entity 105-b may monitor for scheduling via PUCCH, SRS, or both. Thus, the UE 115-c and/or the UE 115-d may transmit corresponding uplink signals in accordance with the UE sleep mode configuration.

At 340, the UE 115-c may perform a cell reselection to set up communication with a cell that is different from the first cell. For example, if the UE 115-c received the group common command indicating the set of neighboring cells, the UE 115-c may perform an RRC reestablishment procedure, a handover procedure, or a redirection procedure with a second cell of the set of neighboring cells based on the group common command.

At 345, the network entity 105-b may optionally transmit an extended sleep instruction to the group of UEs 115. The UE 115-c (e.g., the group of UEs) may receive, based on monitoring during the sleep mode, control signaling that indicates the extended sleep instruction. The UE 115-c may remain in the UE sleep mode for an extended duration of time based on the extended sleep instruction.

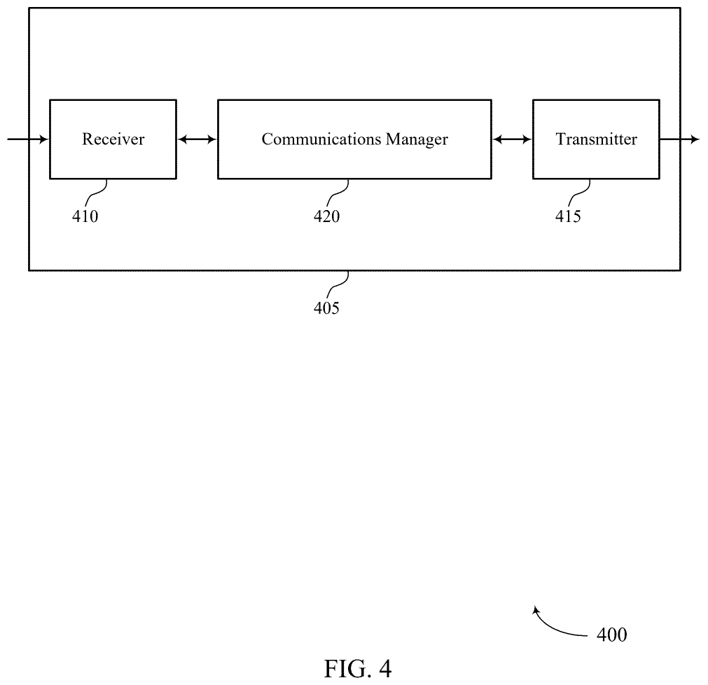

FIG. 4 shows a block diagram 400 of a device 405 that supports group common cell discontinuous reception commands in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, and the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to group common cell discontinuous reception commands). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to group common cell discontinuous reception commands). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of group common cell discontinuous reception commands as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor. If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving, at the first UE and while the first UE is in communication with a first cell, a group common command that indicates that a set of multiple UEs is to enter a sleep mode for a duration of time, where the sleep mode is with respect to communications with the first cell, and where the group common command indicates a configuration for the sleep mode, the set of multiple UEs including the first UE. The communications manager 420 is capable of, configured to, or operable to support a means for transitioning, based on receiving the group common command, to the sleep mode. The communications manager 420 is capable of, configured to, or operable to support a means for monitoring, during the duration of time, one or more downlink channels in the first cell in accordance with the configuration for the sleep mode. The communications manager 420 is capable of, configured to, or operable to transmit, during the duration of time, one or more uplink channels in the first cell in accordance with the configuration for the sleep mode.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for group common cell discontinuous reception commands, which may result in reduced processing, reduced power consumption and more efficient utilization of communication resources, among other advantages, due to an increased ability for a cell and one or more UEs to enter and remain in sleep mode.

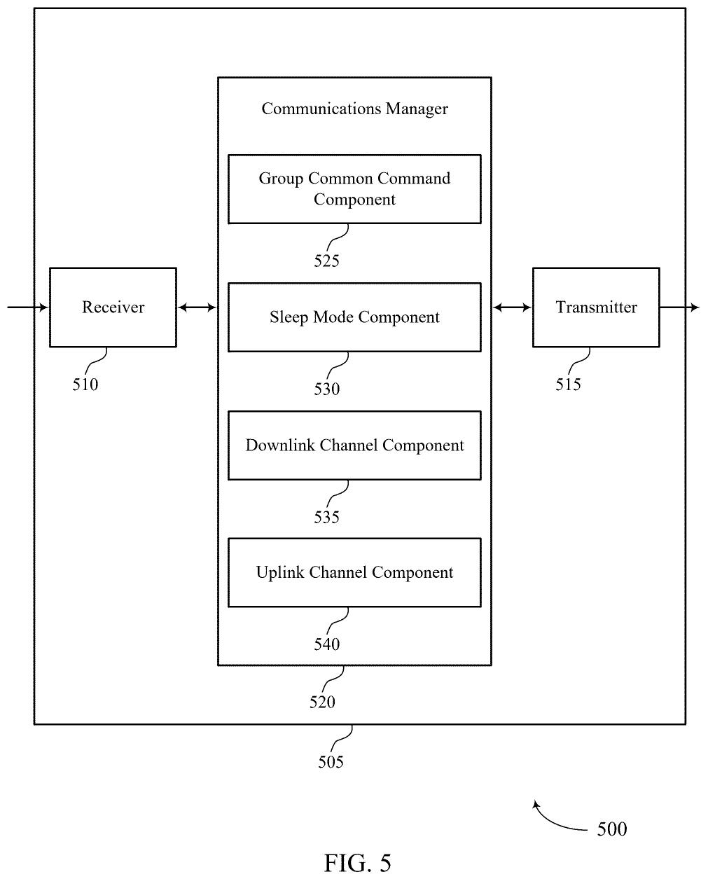

FIG. 5 shows a block diagram 500 of a device 505 that supports group common cell discontinuous reception commands in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to group common cell discontinuous reception commands). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to group common cell discontinuous reception commands). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of group common cell discontinuous reception commands as described herein. For example, the communications manager 520 may include a group common command component 525, a sleep mode component 530, a downlink channel component 535, an uplink channel component 540, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The group common command component 525 is capable of, configured to, or operable to support a means for receiving, at the first UE and while the first UE is in communication with a first cell, a group common command that indicates that a set of multiple UEs is to enter a sleep mode for a duration of time, where the sleep mode is with respect to communications with the first cell, and where the group common command indicates a configuration for the sleep mode, the set of multiple UEs including the first UE. The sleep mode component 530 is capable of, configured to, or operable to support a means for transitioning, based on receiving the group common command, to the sleep mode. The downlink channel component 535 is capable of, configured to, or operable to support a means for monitoring, during the duration of time, one or more downlink channels in the first cell in accordance with the configuration for the sleep mode.

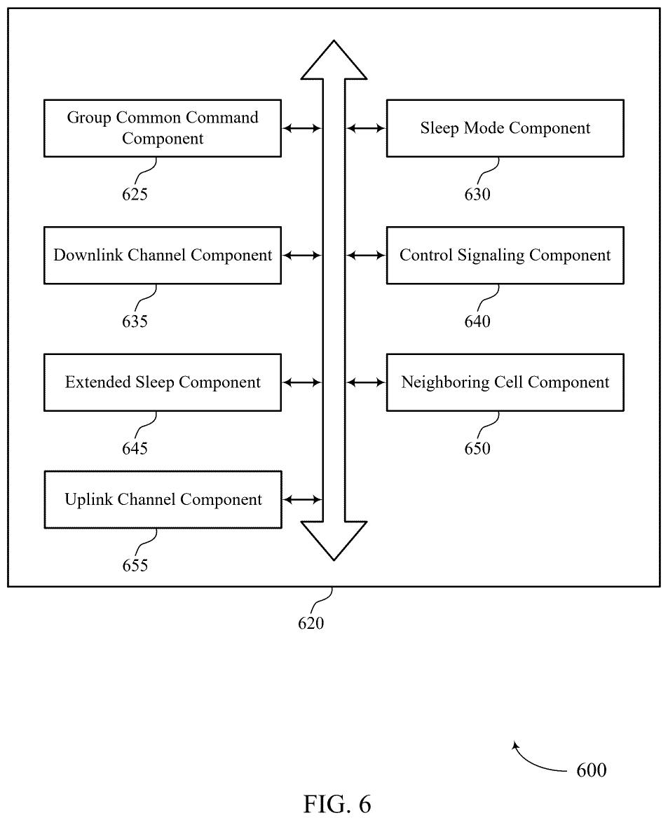

FIG. 6 shows a block diagram 600 of a communications manager 620 that supports group common cell discontinuous reception commands in accordance with one or more aspects of the present disclosure. The communications manager 620 may be an example of aspects of a communications manager 420, a communications manager 520, or both, as described herein. The communications manager 620, or various components thereof, may be an example of means for performing various aspects of group common cell discontinuous reception commands as described herein. For example, the communications manager 620 may include a group common command component 625, a sleep mode component 630, a downlink channel component 635, a control signaling component 640, an extended sleep component 645, a neighboring cell component 650, an uplink channel component 655, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The group common command component 625 is capable of, configured to, or operable to support a means for receiving, at the first UE and while the first UE is in communication with a first cell, a group common command that indicates that a set of multiple UEs is to enter a sleep mode for a duration of time, where the sleep mode is with respect to communications with the first cell, and where the group common command indicates a configuration for the sleep mode, the set of multiple UEs including the first UE. The sleep mode component 630 is capable of, configured to, or operable to support a means for transitioning, based on receiving the group common command, to the sleep mode. The downlink channel component 635 is capable of, configured to, or operable to support a means for monitoring, during the duration of time, one or more downlink channels in the first cell in accordance with the configuration for the sleep mode.

In some examples, the control signaling component 640 is capable of, configured to, or operable to support a means for receiving, prior to receiving the group common command, control signaling that indicates a configuration for the group common command, where the group common command is received in accordance with the configuration for the group common command.

In some examples, the control signaling includes a radio resource control signal.

In some examples, the control signaling assigns the first UE into a UE group for receiving the group common command. In some examples, the UE group includes the set of multiple UEs.

In some examples, the first UE is assigned to the UE group based on a reference signal measurement, a location of the first UE within the first cell, a mobility condition of the first UE within the first cell or a combination thereof.

In some examples, to support receiving the group common command, the group common command component 625 is capable of, configured to, or operable to support a means for receiving the configuration that indicates a quantity of slots during which the first UE is to remain in the sleep mode for the communications with the first cell, where the first UE monitors the one or more downlink channels during the quantity of slots.

In some examples, to support receiving the group common command, the group common command component 625 is capable of, configured to, or operable to support a means for receiving the configuration that indicates the one or more downlink channels that the first UE is to monitor in accordance with the sleep mode, a periodicity for monitoring the one or more downlink channels, or both.

In some examples, to support receiving the group common command, the group common command component 625 is capable of, configured to, or operable to support a means for receiving the configuration that indicates one or more uplink channels that the first UE is to use for uplink transmission in accordance with the sleep mode, a periodicity for the one or more uplink channels, or both.

In some examples, to support receiving the group common command, the group common command component 625 is capable of, configured to, or operable to support a means for receiving the group common command that indicates a set of neighboring cells.

In some examples, the neighboring cell component 650 is capable of, configured to, or operable to support a means for performing a radio resource control reestablishment procedure with a second cell of the set of neighboring cells based on the group common command.

In some examples, the extended sleep component 645 is capable of, configured to, or operable to support a means for receiving, based on monitoring during the sleep mode, control signaling that indicates an extended sleep instruction, where the first UE remains in the sleep mode for an extended duration of time based on the extended sleep instruction.

In some examples, the configuration for the sleep mode overrides a discontinuous reception cycle configured at the first UE.

In some examples, the sleep mode includes a discontinuous transmission mode, a discontinuous reception mode, or both.

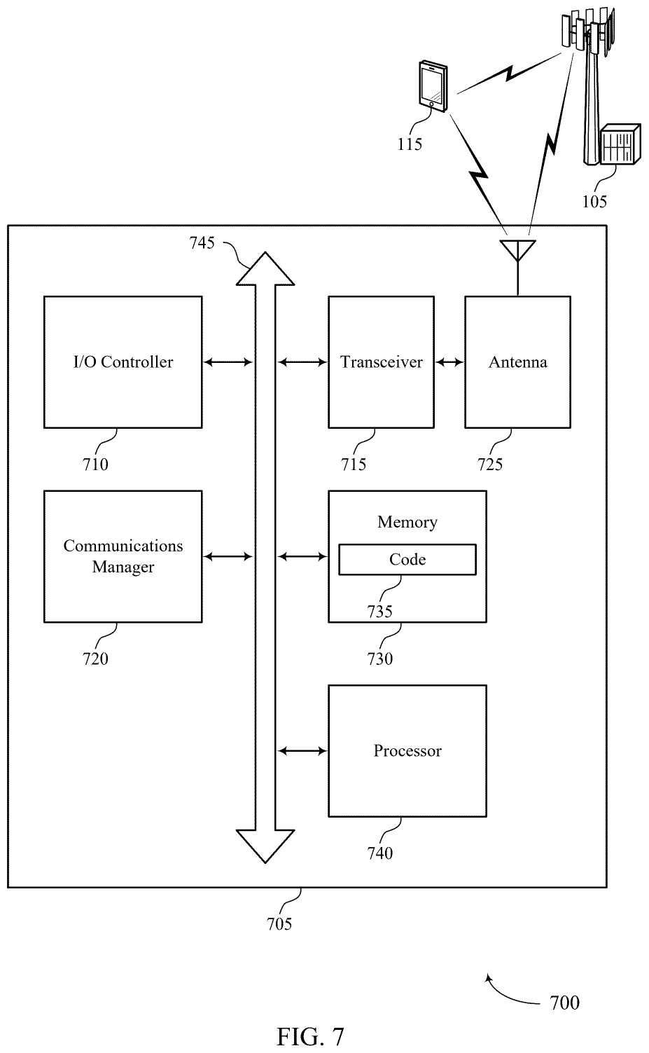

FIG. 7 shows a diagram of a system 700 including a device 705 that supports group common cell discontinuous reception commands in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable code 735 including instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may contain, among other things, a basic I/O system (BIOS) which may control basic hardware or software operation such as the interaction with peripheral components or devices.

The at least one processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting group common cell discontinuous reception commands). For example, the device 705 or a component of the device 705 may include at least one processor 740 and at least one memory 730 coupled with or to the at least one processor 740, the at least one processor 740 and at least one memory 730 configured to perform various functions described herein. In some examples, the at least one processor 740 may include multiple processors and the at least one memory 730 may include multiple memories. One or more of the multiple processors may be coupled with one or more of the multiple memories, which may, individually or collectively, be configured to perform various functions herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving, at the first UE and while the first UE is in communication with a first cell, a group common command that indicates that a set of multiple UEs is to enter a sleep mode for a duration of time, where the sleep mode is with respect to communications with the first cell, and where the group common command indicates a configuration for the sleep mode, the set of multiple UEs including the first UE. The communications manager 720 is capable of, configured to, or operable to support a means for transitioning, based on receiving the group common command, to the sleep mode. The communications manager 720 is capable of, configured to, or operable to support a means for monitoring, during the duration of time, one or more downlink channels in the first cell in accordance with the configuration for the sleep mode. The communications manager 720 is capable of, configured to, or operable to support a means for transmitting, during the duration of time, one or more uplink channels in the first cell in accordance with the configuration of the sleep mode.

By including or configuring the communications manager 720 in accordance with examples as described herein, the device 705 may support techniques for group common cell discontinuous reception commands, which may result in improved user experience related to reduced processing, reduced power consumption, more efficient utilization of communication resources, improved coordination between devices, longer battery life, improved utilization of processing capability, among other advantages, due to an increased ability for a cell and one or more UEs to enter and remain in sleep mode.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of group common cell discontinuous reception commands as described herein, or the at least one processor 740 and the at least one memory 730 may be otherwise configured to, individually or collectively, perform or support such operations.

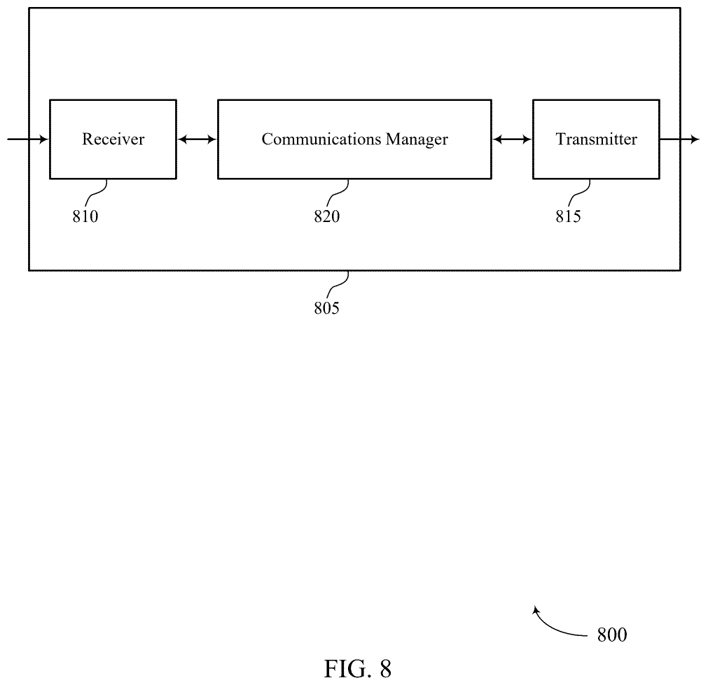

FIG. 8 shows a block diagram 800 of a device 805 that supports group common cell discontinuous reception commands in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of group common cell discontinuous reception commands as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor. If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for outputting a group common command that indicates that a set of multiple user equipments (UEs) in communication with a first cell is to enter a sleep mode for a duration of time, where the sleep mode is with respect to communications with the first cell, and where the group common command indicates a configuration for the sleep mode. The communications manager 820 is capable of, configured to, or operable to support a means for transitioning, based on outputting the group common command, to the sleep mode. The communications manager 820 is capable of, configured to, or operable to support a means for monitoring, during the duration of time, one or more uplink channels in the first cell in accordance with the configuration for the sleep mode. The communications manager 820 is capable of, configured to, or operable to support a means for transmitting, during the duration of time, one or more downlink channels in the first cell in accordance with the configuration for the sleep mode.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for group common cell discontinuous reception commands, which may result in reduced processing, reduced power consumption and more efficient utilization of communication resources, among other advantages, due to an increased ability for a cell and one or more UEs to enter and remain in sleep mode.

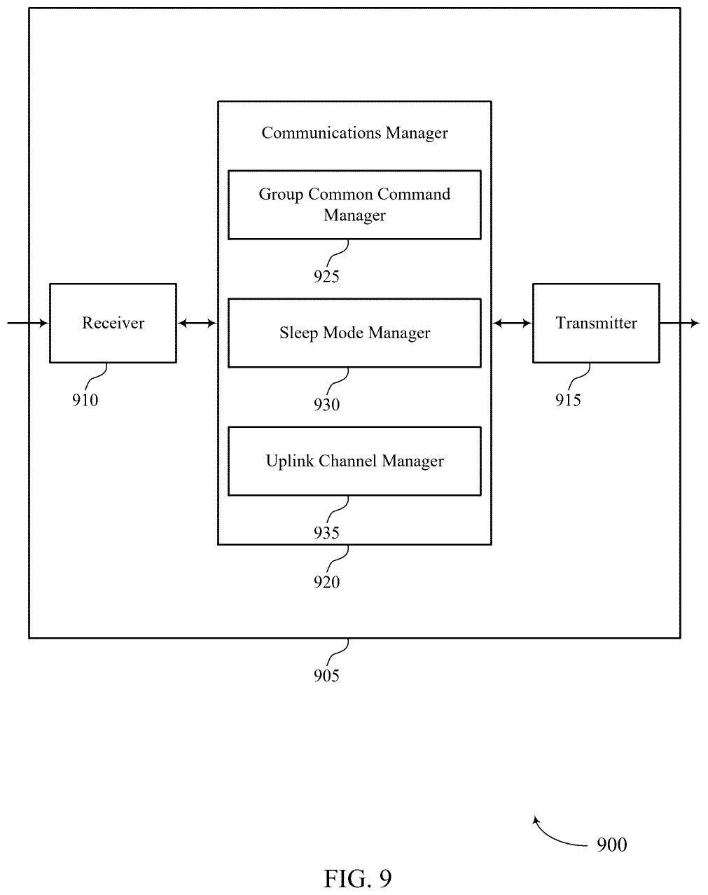

FIG. 9 shows a block diagram 900 of a device 905 that supports group common cell discontinuous reception commands in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of group common cell discontinuous reception commands as described herein. For example, the communications manager 920 may include a group common command manager 925, a sleep mode manager 930, an uplink channel manager 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The group common command manager 925 is capable of, configured to, or operable to support a means for outputting a group common command that indicates that a set of multiple user equipments (UEs) in communication with a first cell is to enter a sleep mode for a duration of time, where the sleep mode is with respect to communications with the first cell, and where the group common command indicates a configuration for the sleep mode. The sleep mode manager 930 is capable of, configured to, or operable to support a means for transitioning, based on outputting the group common command, to the sleep mode. The uplink channel manager 935 is capable of, configured to, or operable to support a means for monitoring, during the duration of time, one or more uplink channels in the first cell in accordance with the configuration for the sleep mode.

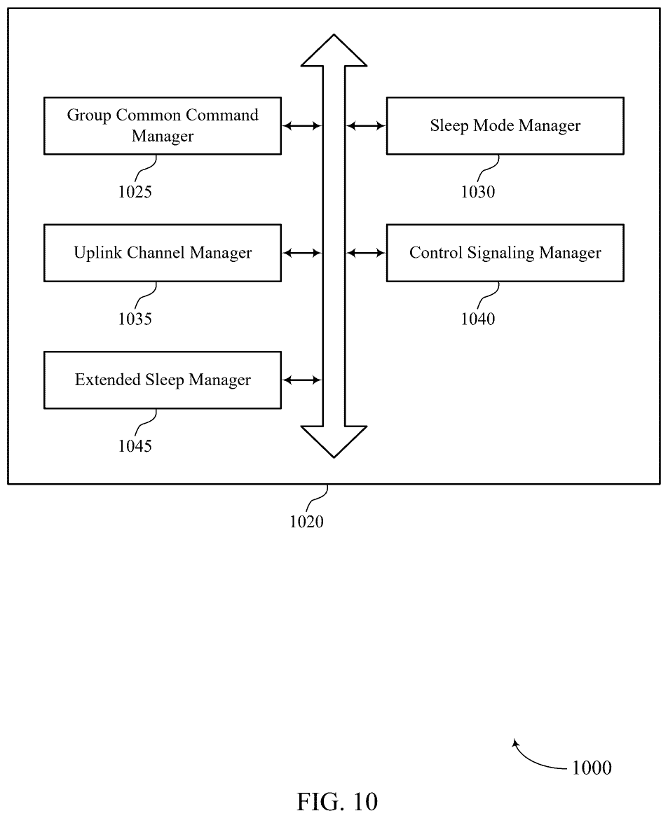

FIG. 10 shows a block diagram 1000 of a communications manager 1020 that supports group common cell discontinuous reception commands in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of group common cell discontinuous reception commands as described herein. For example, the communications manager 1020 may include a group common command manager 1025, a sleep mode manager 1030, an uplink channel manager 1035, a control signaling manager 1040, an extended sleep manager 1045, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The group common command manager 1025 is capable of, configured to, or operable to support a means for outputting a group common command that indicates that a set of multiple user equipments (UEs) in communication with a first cell is to enter a sleep mode for a duration of time, where the sleep mode is with respect to communications with the first cell, and where the group common command indicates a configuration for the sleep mode. The sleep mode manager 1030 is capable of, configured to, or operable to support a means for transitioning, based on outputting the group common command, to the sleep mode. The uplink channel manager 1035 is capable of, configured to, or operable to support a means for monitoring, during the duration of time, one or more uplink channels in the first cell in accordance with the configuration for the sleep mode.

In some examples, the control signaling manager 1040 is capable of, configured to, or operable to support a means for outputting, prior to outputting the group common command, control signaling that indicates a configuration for the group common command, where the group common command is output in accordance with the configuration for the group common command.

In some examples, the control signaling includes a radio resource control signal.

In some examples, the control signaling assigns one or more UEs into a UE group for receiving the group common command. In some examples, the UE group includes the set of multiple UEs.

In some examples, the one or more UEs are assigned to the UE group based on a reference signal measurement, a location of the one or more UEs within the first cell, or a combination thereof.

In some examples, to support outputting the group common command, the group common command manager 1025 is capable of, configured to, or operable to support a means for outputting the configuration that indicates a quantity of slots during which the set of multiple UEs is to remain in the sleep mode for the communications with the first cell, where the network entity monitors the one or more uplink channels in accordance with the configuration.

In some examples, to support outputting the group common command, the group common command manager 1025 is capable of, configured to, or operable to support a means for outputting the configuration that indicates one or more downlink channels that the set of multiple UEs is to monitor in accordance with the sleep mode, a periodicity for monitoring the one or more downlink channels, or both.

In some examples, to support outputting the group common command, the group common command manager 1025 is capable of, configured to, or operable to support a means for outputting the configuration that indicates the one or more uplink channels that the set of multiple UEs is to use for uplink transmission in accordance with the sleep mode, a periodicity for the one or more uplink channels, or both.

In some examples, to support outputting the group common command, the group common command manager 1025 is capable of, configured to, or operable to support a means for outputting the group common command that indicates a set of neighboring cells.

In some examples, the extended sleep manager 1045 is capable of, configured to, or operable to support a means for outputting, based on monitoring during the sleep mode, control signaling that indicates an extended sleep instruction, where the network entity remains in the sleep mode for an extended duration of time based on the extended sleep instruction.

In some examples, the configuration for the sleep mode overrides a discontinuous reception cycle configured at one or more UEs of the set of multiple UEs.

In some examples, the sleep mode includes a discontinuous transmission mode, a discontinuous reception mode, or both.

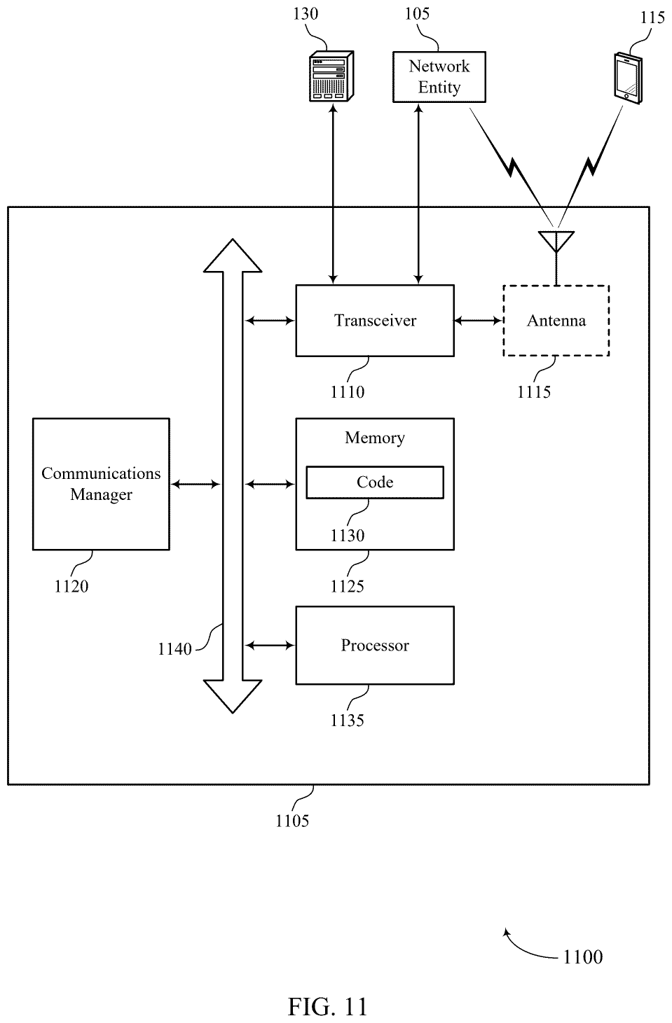

FIG. 11 shows a diagram of a system 1100 including a device 1105 that supports group common cell discontinuous reception commands in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., a communication link 125, a backhaul communication link 120, a midhaul communication link 162, a fronthaul communication link 168).

The at least one memory 1125 may include RAM, ROM, or any combination thereof. The at least one memory 1125 may store computer-readable, computer-executable code 1130 including instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may contain, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting group common cell discontinuous reception commands). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125). In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for outputting a group common command that indicates that a set of multiple user equipments (UEs) in communication with a first cell is to enter a sleep mode for a duration of time, where the sleep mode is with respect to communications with the first cell, and where the group common command indicates a configuration for the sleep mode. The communications manager 1120 is capable of, configured to, or operable to support a means for transitioning, based on outputting the group common command, to the sleep mode. The communications manager 1120 is capable of, configured to, or operable to support a means for monitoring, during the duration of time, one or more uplink channels in the first cell in accordance with the configuration for the sleep mode.

By including or configuring the communications manager 1120 in accordance with examples as described herein, the device 1105 may support techniques for group common cell discontinuous reception commands, which may result in improved user experience related to reduced processing, reduced power consumption, more efficient utilization of communication resources, improved coordination between devices, longer battery life, improved utilization of processing capability, among other advantages, due to an increased ability for a cell and one or more UEs to enter and remain in sleep mode.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of group common cell discontinuous reception commands as described herein, or the at least one processor 1135 and the at least one memory 1125 may be otherwise configured to, individually or collectively, perform or support such operations.

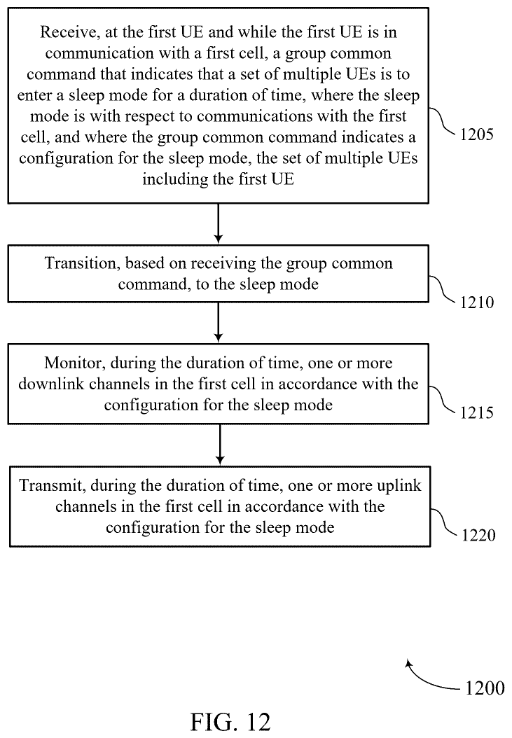

FIG. 12 shows a flowchart illustrating a method 1200 that supports group common cell discontinuous reception commands in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving, at the first UE and while the first UE is in communication with a first cell, a group common command that indicates that a set of multiple UEs is to enter a sleep mode for a duration of time, where the sleep mode is with respect to communications with the first cell, and where the group common command indicates a configuration for the sleep mode, the set of multiple UEs including the first UE. The operations of block 1205 may be performed in accordance with examples as disclosed herein. In some examples, aspects of the operations of 1205 may be performed by a group common command component 625 as described with reference to FIG. 6.

At 1210, the method may include transitioning, based on receiving the group common command, to the sleep mode. The operations of block 1210 may be performed in accordance with examples as disclosed herein. In some examples, aspects of the operations of 1210 may be performed by a sleep mode component 630 as described with reference to FIG. 6.

At 1215, the method may include monitoring, during the duration of time, one or more downlink channels in the first cell in accordance with the configuration for the sleep mode. The operations of block 1215 may be performed in accordance with examples as disclosed herein. In some examples, aspects of the operations of 1215 may be performed by a downlink channel component 635 as described with reference to FIG. 6.

At 1220 the method may include transmitting, during the duration of time, one or more uplink channels in the first cell in accordance with the configuration for the sleep mode. The operations of block 1220 may be performed in accordance with examples as disclosed herein. In some examples, aspects of the operations of 1220 may be performed by the uplink channel component 655 as described with reference to FIG. 6.

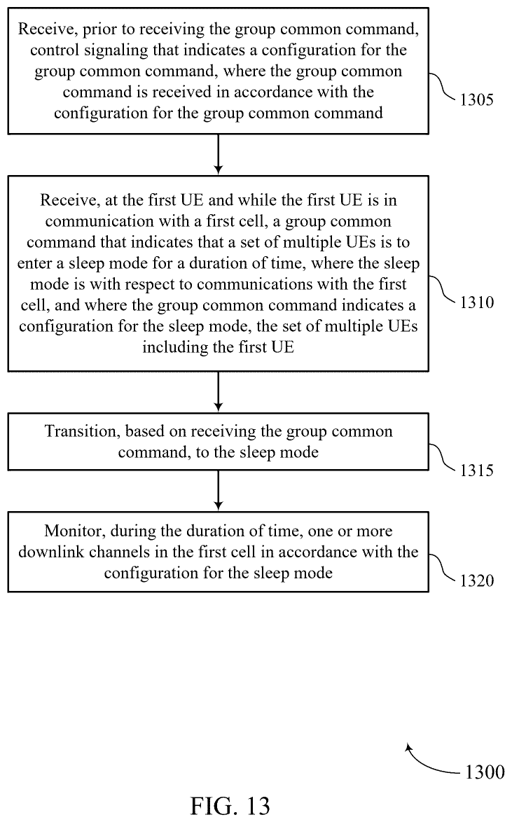

FIG. 13 shows a flowchart illustrating a method 1300 that supports group common cell discontinuous reception commands in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving, prior to receiving the group common command, control signaling that indicates a configuration for the group common command, where the group common command is received in accordance with the configuration for the group common command. The operations of block 1305 may be performed in accordance with examples as disclosed herein. In some examples, aspects of the operations of 1305 may be performed by a control signaling component 640 as described with reference to FIG. 6.

At 1310, the method may include receiving, at the first UE and while the first UE is in communication with a first cell, a group common command that indicates that a set of multiple UEs is to enter a sleep mode for a duration of time, where the sleep mode is with respect to communications with the first cell, and where the group common command indicates a configuration for the sleep mode, the set of multiple UEs including the first UE. The operations of block 1310 may be performed in accordance with examples as disclosed herein. In some examples, aspects of the operations of 1310 may be performed by a group common command component 625 as described with reference to FIG. 6.

At 1315, the method may include transitioning, based on receiving the group common command, to the sleep mode. The operations of block 1315 may be performed in accordance with examples as disclosed herein. In some examples, aspects of the operations of 1315 may be performed by a sleep mode component 630 as described with reference to FIG. 6.

At 1320, the method may include monitoring, during the duration of time, one or more downlink channels in the first cell in accordance with the configuration for the sleep mode. The operations of block 1320 may be performed in accordance with examples as disclosed herein. In some examples, aspects of the operations of 1320 may be performed by a downlink channel component 635 as described with reference to FIG. 6.

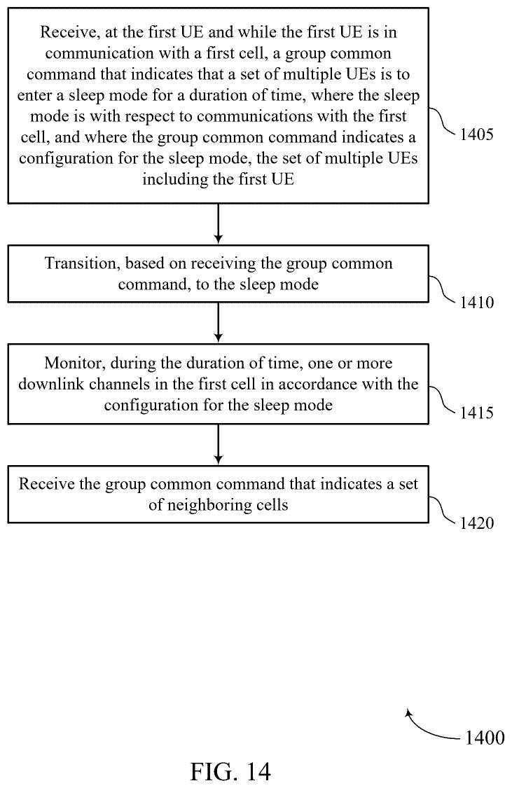

FIG. 14 shows a flowchart illustrating a method 1400 that supports group common cell discontinuous reception commands in accordance with one or more aspects of the present disclosure. The operations of the method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1405, the method may include receiving, at the first UE and while the first UE is in communication with a first cell, a group common command that indicates that a set of multiple UEs is to enter a sleep mode for a duration of time, where the sleep mode is with respect to communications with the first cell, and where the group common command indicates a configuration for the sleep mode, the set of multiple UEs including the first UE. The operations of block 1405 may be performed in accordance with examples as disclosed herein. In some examples, aspects of the operations of 1405 may be performed by a group common command component 625 as described with reference to FIG. 6.

At 1410, the method may include transitioning, based on receiving the group common command, to the sleep mode. The operations of block 1410 may be performed in accordance with examples as disclosed herein. In some examples, aspects of the operations of 1410 may be performed by a sleep mode component 630 as described with reference to FIG. 6.

At 1415, the method may include monitoring, during the duration of time, one or more downlink channels in the first cell in accordance with the configuration for the sleep mode. The operations of block 1415 may be performed in accordance with examples as disclosed herein. In some examples, aspects of the operations of 1415 may be performed by a downlink channel component 635 as described with reference to FIG. 6.

At 1420, the method may include receiving the group common command that indicates a set of neighboring cells. The operations of block 1420 may be performed in accordance with examples as disclosed herein. In some examples, aspects of the operations of 1420 may be performed by a group common command component 625 as described with reference to FIG. 6.

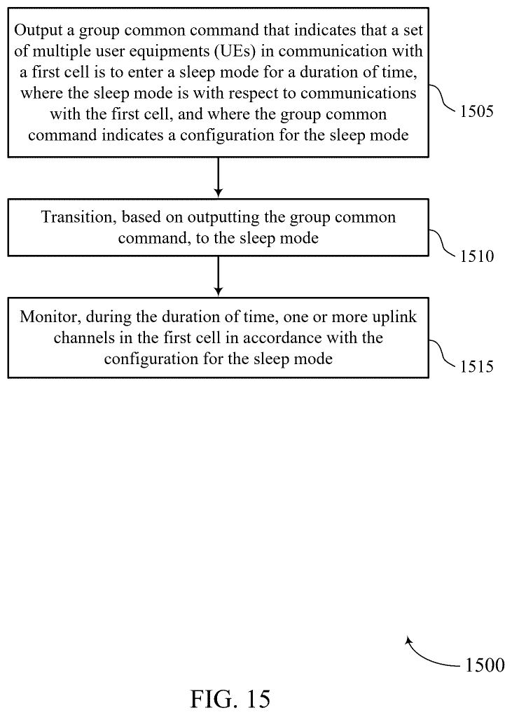

FIG. 15 shows a flowchart illustrating a method 1500 that supports group common cell discontinuous reception commands in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include outputting a group common command that indicates that a set of multiple user equipments (UEs) in communication with a first cell is to enter a sleep mode for a duration of time, where the sleep mode is with respect to communications with the first cell, and where the group common command indicates a configuration for the sleep mode. The operations of block 1505 may be performed in accordance with examples as disclosed herein. In some examples, aspects of the operations of 1505 may be performed by a group common command manager 1025 as described with reference to FIG. 10.

At 1510, the method may include transitioning, based on outputting the group common command, to the sleep mode. The operations of block 1510 may be performed in accordance with examples as disclosed herein. In some examples, aspects of the operations of 1510 may be performed by a sleep mode manager 1030 as described with reference to FIG. 10.

At 1515, the method may include monitoring, during the duration of time, one or more uplink channels in the first cell in accordance with the configuration for the sleep mode. The operations of block 1515 may be performed in accordance with examples as disclosed herein. In some examples, aspects of the operations of 1515 may be performed by an uplink channel manager 1035 as described with reference to FIG. 10.

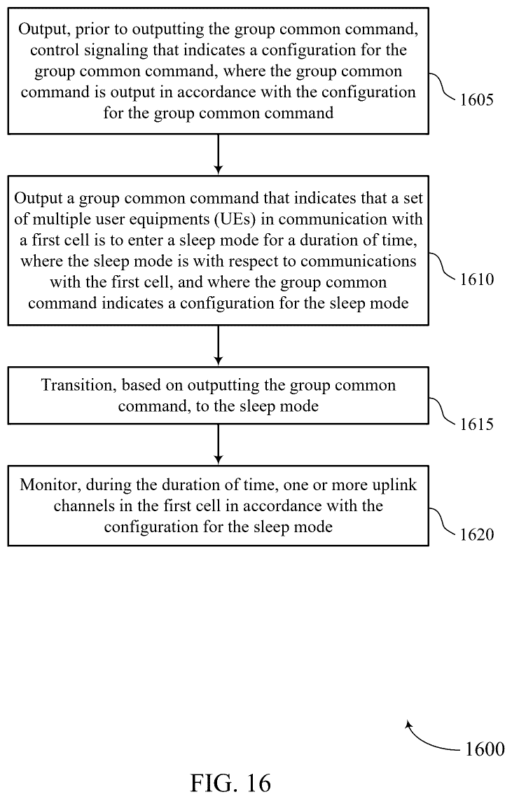

FIG. 16 shows a flowchart illustrating a method 1600 that supports group common cell discontinuous reception commands in accordance with one or more aspects of the present disclosure. The operations of the method 1600 may be implemented by a network entity or its components as described herein. For example, the operations of the method 1600 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1605, the method may include outputting, prior to outputting the group common command, control signaling that indicates a configuration for the group common command, where the group common command is output in accordance with the configuration for the group common command. The operations of block 1605 may be performed in accordance with examples as disclosed herein. In some examples, aspects of the operations of 1605 may be performed by a control signaling manager 1040 as described with reference to FIG. 10.

At 1610, the method may include outputting a group common command that indicates that a set of multiple user equipments (UEs) in communication with a first cell is to enter a sleep mode for a duration of time, where the sleep mode is with respect to communications with the first cell, and where the group common command indicates a configuration for the sleep mode. The operations of block 1610 may be performed in accordance with examples as disclosed herein. In some examples, aspects of the operations of 1610 may be performed by a group common command manager 1025 as described with reference to FIG. 10.

At 1615, the method may include transitioning, based on outputting the group common command, to the sleep mode. The operations of block 1615 may be performed in accordance with examples as disclosed herein. In some examples, aspects of the operations of 1615 may be performed by a sleep mode manager 1030 as described with reference to FIG. 10.

At 1620, the method may include monitoring, during the duration of time, one or more uplink channels in the first cell in accordance with the configuration for the sleep mode. The operations of block 1620 may be performed in accordance with examples as disclosed herein. In some examples, aspects of the operations of 1620 may be performed by an uplink channel manager 1035 as described with reference to FIG. 10.

The following provides an overview of aspects of the present disclosure:

Aspect 1: A method for wireless communications at a first UE, comprising: receiving, at the first UE and while the first UE is in communication with a first cell, a group common command that indicates that a plurality of UEs is to enter a sleep mode for a duration of time, wherein the sleep mode is with respect to communications with the first cell, and wherein the group common command indicates a configuration for the sleep mode, the plurality of UEs including the first UE; transitioning, based at least in part on receiving the group common command, to the sleep mode; and monitoring, during the duration of time, one or more downlink channels in the first cell in accordance with the configuration for the sleep mode; and transmitting, during the duration of time, one or more uplink channels in the first cell in accordance with the configuration for the sleep mode.

Aspect 2: The method of aspect 1, further comprising: receiving, prior to receiving the group common command, control signaling that indicates a configuration for the group common command, wherein the group common command is received in accordance with the configuration for the group common command.

Aspect 3: The method of aspect 2, wherein the control signaling indicating the configuration for the group common command comprises a radio resource control signal.

Aspect 4: The method of any of aspects 2 through 3, wherein the control signaling assigns the first UE into a UE group for receiving the group common command, and the UE group comprises the plurality of UEs.

Aspect 5: The method of aspect 4, wherein the first UE is assigned to the UE group based at least in part on a reference signal measurement, a location of the first UE within the first cell, a mobility condition of the UE in the first cell, or a combination thereof.

Aspect 6: The method of any of aspects 1 through 5, wherein receiving the group common command further comprises: receiving the configuration that indicates a quantity of slots during which the first UE is to remain in the sleep mode for the communications with the first cell, wherein the first UE monitors the one or more downlink channels during the quantity of slots.

Aspect 7: The method of any of aspects 1 through 6, wherein receiving the group common command further comprises: receiving the configuration that indicates the one or more downlink channels that the first UE is to monitor in accordance with the sleep mode, a periodicity for monitoring the one or more downlink channels, or both.

Aspect 8: The method of any of aspects 1 through 7, wherein receiving the group common command further comprises: receiving the configuration that indicates one or more uplink channels that the first UE is to use for uplink transmission in accordance with the sleep mode, a periodicity for the one or more uplink channels, or both.

Aspect 9: The method of any of aspects 1 through 8, wherein receiving the group common command further comprises: receiving the group common command that indicates a set of neighboring cells.

Aspect 10: The method of aspect 9, further comprising: performing a radio resource control reestablishment procedure with a second cell of the set of neighboring cells based at least in part on the group common command.

Aspect 11: The method of any of aspects 1 through 10, further comprising: receiving, based at least in part on monitoring during the sleep mode, control signaling that indicates an extended sleep instruction, wherein the first UE remains in the sleep mode for an extended duration of time based at least in part on the extended sleep instruction.

Aspect 12: The method of any of aspects 1 through 11, wherein the configuration for the sleep mode overrides a discontinuous reception cycle configured at the first UE.

Aspect 13: The method of any of aspects 1 through 12, wherein the sleep mode comprises a discontinuous transmission mode, a discontinuous reception mode, or both. Aspect 14: The method of any of aspects 1 through 12, wherein the group common command comprises a medium access control layer control element (MAC-CE) message or a downlink control information message.

Aspect 15: A method for wireless communications at a network entity, comprising: outputting a group common command that indicates that a plurality of UEs in communication with a first cell is to enter a sleep mode for a duration of time, wherein the sleep mode is with respect to communications with the first cell, and wherein the group common command indicates a configuration for the sleep mode; transitioning, based at least in part on outputting the group common command, to the sleep mode; and monitoring, during the duration of time, one or more uplink channels in the first cell in accordance with the configuration for the sleep mode.

Aspect 16: The method of aspect 15, further comprising: outputting, prior to outputting the group common command, control signaling that indicates a configuration for the group common command, wherein the group common command is output in accordance with the configuration for the group common command.

Aspect 17: The method of aspect 16, wherein the control signaling comprises a radio resource control signal.

Aspect 18: The method of any of aspects 16 through 17, wherein the control signaling assigns one or more UEs into a UE group for receiving the group common command, the UE group comprises the plurality of UEs.

Aspect 19: The method of aspect 18, wherein the one or more UEs are assigned to the UE group based at least in part on a reference signal measurement, a location of the one or more UEs within the first cell, or a combination thereof.

Aspect 20: The method of any of aspects 15 through 19, wherein outputting the group common command further comprises: outputting the configuration that indicates a quantity of slots during which the plurality of UEs is to remain in the sleep mode for the communications with the first cell, wherein the network entity monitors the one or more uplink channels in accordance with the configuration.

Aspect 21: The method of any of aspects 15 through 20, wherein outputting the group common command further comprises: outputting the configuration that indicates one or more downlink channels that the plurality of UEs is to monitor in accordance with the sleep mode, a periodicity for monitoring the one or more downlink channels, or both.

Aspect 22: The method of any of aspects 15 through 21, wherein outputting the group common command further comprises: outputting the configuration that indicates the one or more uplink channels that the plurality of UEs is to use for uplink transmission in accordance with the sleep mode, a periodicity for the one or more uplink channels, or both.

Aspect 23: The method of any of aspects 15 through 22, wherein outputting the group common command further comprises: outputting the group common command that indicates a set of neighboring cells.

Aspect 24: The method of any of aspects 15 through 23, further comprising: outputting, based at least in part on monitoring during the sleep mode, control signaling that indicates an extended sleep instruction, wherein the network entity remains in the sleep mode for an extended duration of time based at least in part on the extended sleep instruction.

Aspect 25: The method of any of aspects 15 through 24, wherein the configuration for the sleep mode overrides a discontinuous reception cycle configured at one or more UEs of the plurality of UEs.

Aspect 26: The method of any of aspects 15 through 25, wherein the sleep mode comprises a discontinuous transmission mode, a discontinuous reception mode, or both.

Aspect 27: The method of any of aspects 15 through 25, wherein the group common command comprises a medium access control layer control element (MAC-CE) message or a downlink control information message.

Aspect 28: A first UE for wireless communications, comprising one or more memories storing processor-executable code, and one or more processors coupled with the one or more memories and individually or collectively operable to execute the code to cause the first UE to perform a method of any of aspects 1 through 13.

Aspect 29: A first UE for wireless communications, comprising at least one means for performing a method of any of aspects 1 through 13.

Aspect 30: A non-transitory computer-readable medium storing code for wireless communications, the code comprising instructions executable by one or more processors to perform a method of any of aspects 1 through 13.

Aspect 31: A network entity for wireless communications, comprising one or more memories storing processor-executable code, and one or more processors coupled with the one or more memories and individually or collectively operable to execute the code to cause the network entity to perform a method of any of aspects 15 through 26.

Aspect 32: A network entity for wireless communications, comprising at least one means for performing a method of any of aspects 15 through 26.

Aspect 33: A non-transitory computer-readable medium storing code for wireless communications, the code comprising instructions executable by one or more processors to perform a method of any of aspects 15 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first user equipment (UE), comprising:
one or more memories storing processor-executable code; and
one or more processors coupled with the one or more memories and individually or collectively operable to execute the code to cause the first UE to:
receive, at the first UE and while the first UE is in communication with a first cell, a group common command that indicates that a plurality of UEs is to enter a sleep mode for a duration of time, wherein the sleep mode is with respect to communications with the first cell, and wherein the group common command indicates a configuration for the sleep mode, the plurality of UEs including the first UE;
transition, based at least in part on receiving the group common command, to the sleep mode;
monitor, during the duration of time, one or more downlink channels in the first cell in accordance with the configuration for the sleep mode; and
transmit, during the duration of time, one or more uplink channels in the first cell in accordance with the configuration for the sleep mode.

2. The first UE of claim 1, wherein the one or more processors are individually or collectively further operable to execute the code to cause the first UE to:
receive, prior to receiving the group common command, control signaling that indicates a configuration for the group common command, wherein the group common command is received in accordance with the configuration for the group common command.

3. The first UE of claim 2, wherein the control signaling indicating the configuration for the group common command comprises a radio resource control signal.

4. The first UE of claim 2, wherein the control signaling assigns the first UE into a UE group for receiving the group common command and wherein the UE group comprises the plurality of UEs.

5. The first UE of claim 4, wherein the first UE is assigned to the UE group based at least in part on a reference signal measurement, a location of the first UE within the first cell, or mobility of the first UE within the first cell, or an application quality of experience (QoE) metric for the first UE within the first cell, or any combination thereof.

6. The first UE of claim 2, wherein the group common command comprises medium access control layer control element (MAC-CE) message or a downlink control information message.

7. The first UE of claim 1, wherein, to receive the group common command, the one or more processors are individually or collectively further operable to execute the code to cause the first UE to:
receive the configuration that indicates a quantity of slots during which the first UE is to remain in the sleep mode for the communications with the first cell, wherein the first UE monitors the one or more downlink channels during the quantity of slots.

8. The first UE of claim 1, wherein, to receive the group common command, the one or more processors are individually or collectively further operable to execute the code to cause the first UE to:
receive the configuration that indicates the one or more downlink channels that the first UE is to monitor in accordance with the sleep mode, a periodicity for monitoring the one or more downlink channels, or both.

9. The first UE of claim 1, wherein, to receive the group common command, the one or more processors are individually or collectively further operable to execute the code to cause the first UE to:
receive the configuration that indicates the one or more uplink channels that the first UE is to use for uplink transmission in accordance with the sleep mode, a periodicity for the one or more uplink channels, or both.

10. The first UE of claim 1, wherein the configuration is indicative of a set of neighboring cells.

11. The first UE of claim 10, wherein the one or more processors are individually or collectively further operable to execute the code to cause the first UE to:
perform a radio resource control reestablishment, a handover procedure, or a redirection procedure with a second cell of the set of neighboring cells based at least in part on the group common command.

12. The first UE of claim 1, wherein the one or more processors are individually or collectively further operable to execute the code to cause the first UE to:
receive, based at least in part on monitoring during the sleep mode, control signaling that indicates an extended sleep instruction, wherein the first UE remains in the sleep mode for an extended duration of time based at least in part on the extended sleep instruction.

13. The first UE of claim 1, wherein the configuration for the sleep mode overrides a discontinuous reception cycle configured at the first UE.

14. The first UE of claim 1, wherein the sleep mode comprises a discontinuous transmission mode, a discontinuous reception mode, or both.

15. A method for wireless communications at a first user equipment (UE), comprising:
receiving, at the first UE and while the first UE is in communication with a first cell, a group common command that indicates that a plurality of UEs is to enter a sleep mode for a duration of time, wherein the sleep mode is with respect to communications with the first cell, and wherein the group common command indicates a configuration for the sleep mode the plurality of UEs including the first UE;
transitioning, based at least in part on receiving the group common command, to the sleep mode;
monitoring, during the duration of time, one or more downlink channels in the first cell in accordance with the configuration for the sleep mode; and
transmitting, during the duration of time, one or more uplink channels in the first cell in accordance with the configuration for the sleep mode.

16. The method of claim 15, wherein receiving the group common command further comprises:
receiving the configuration that indicates a quantity of slots during which the first UE is to remain in the sleep mode for the communications with the first cell, wherein the first UE monitors the one or more downlink channels during the quantity of slots.

17. The method of claim 15, wherein receiving the group common command further comprises:
receiving the configuration that indicates the one or more downlink channels that the first UE is to monitor in accordance with the sleep mode, a periodicity for monitoring the one or more downlink channels, or both.

18. The method of claim 15, wherein receiving the group common command further comprises:
receiving the configuration that indicates the one or more uplink channels that the first UE is to use for uplink transmission in accordance with the sleep mode, a periodicity for the one or more uplink channels, or both.

19. The method of claim 15, wherein receiving the group common command further comprises:
receiving the group common command that indicates a set of neighboring cells.

20. A first user equipment (UE) for wireless communications, comprising:
means for receiving, at the first UE and while the first UE is in communication with a first cell, a group common command that indicates that a plurality of UEs is to enter a sleep mode for a duration of time, wherein the sleep mode is with respect to communications with the first cell, and wherein the group common command indicates a configuration for the sleep mode, the plurality of UEs including the first UE;
means for transitioning, based at least in part on receiving the group common command, to the sleep mode;
means for monitoring, during the duration of time, one or more downlink channels in the first cell in accordance with the configuration for the sleep mode; and
means for transmitting, during the duration of time, one or more uplink channels in the first cell in accordance with the configuration for the sleep mode.
